(19) United States
(12) Patent Application Publication
(10) Pub. No.: US 2001/0051174 A1
(43) Pub. Date: Dec. 13, 2001

(54) Composition and method of treating trees and plants for protection against destructive organisms

(76) Inventor: Victor J. Staats, Lake Worth, FL (US)

Correspondence Address: Robert M. Downey, ROBERT M. DOWNEY, P.A., Suite 350, 150 E. Palmetto Park Road, Boca Raton, FL, 33432, US

(21) Appl. No.: 09/822,056

(22) Filed: Mar. 30, 2001

Related U.S. Application Data
(60) Provisional application No. 60/193,857, filed on Mar. 30, 2000.
(60) Provisional application No. 60/209,491, filed on Jun. 6, 2000.

(51) Int. Cl. A01N 25/00; A01N 33/12

(52) U.S. Cl. 424/405; 514/642; 514/643

(57) ABSTRACT

An antimicrobial composition, having antiviral, antibacterial, and antifungal properties, is applied to plants and trees by spray coating and/or through systemic delivery to protect against harmful and destructive organisms. The composition includes: one or more quaternary ammonium compounds; a surfactant; a wetting agent; a drying agent; a hydrophilic film forming agent; a hydrophobic water proofing agent; and water.

### BACKGROUND OF THE INVENTION

1. Field of the Invention

The present invention relates to an antiviral, antibacterial, antifungal pesticide composition and, more particularly, to a composition for external application and systemic delivery to plants and trees to protect against harmful pathogens.

2. Discussion of the Related Art

Each year, the U.S. and foreign agricultural industries are faced with hundreds of millions of dollars in losses as a result of infectious diseases which attack the cellular structure of both food producing and ornamental vegetation. For instance, the Florida citrus industry is presently facing significant losses in fruit harvests due to citrus canker. This infection, which forms lesions on leaves, stems and fruit, causes fruit to fall prematurely from trees. Once the fruit has been infected by citrus canker, the fruit can no longer be sold and must be destroyed to prevent further outbreaks of this contagious disease. Eventually, citrus canker kills the tree and spreads to other neighboring trees. To combat the disease, present methods involve burning large areas of trees surrounding the infected trees and fruit. To date, Florida has burned approximately 500,000 citrus trees in the war against this disease, both in back yards and commercial citrus groves. It is feared that outbreaks of citrus canker, which are spreading north from Dade and Broward counties, could have a severe impact on the $8 billion/year Florida citrus industry. At the rate that this contagious disease is spreading, and considering the drastic measures which are presently being used to combat citrus canker, the future of the entire Florida citrus industry is at stake. Absent a solution for isolating, controlling and killing the disease, the devastating affects of citrus canker could range from increased consumer prices for fruit juice and produce to worldwide shortages of citrus fruit and products which contain citrus fruit.

Of equal concern is the devastating threat which the glassy-winged sharpshooter and Pierce's disease pose to both agricultural crops and ornamental plants. The glassy-winged sharpshooter is an insect that recently has become established in Southern California and Pierce's disease. Pierce's disease, a bacterium spread by the sharpshooter, can kill grapevines, as well as a host of other plants and agricultural products including almonds, alfalfa, apricots, cherries, citrus, peaches and ornamentals. The disease has already caused millions of dollars in damage to California's grape and wine industries. It is estimated that the sharpshooter and Pierce's disease threaten more than $14 billion in agricultural crops in California alone.

While there are several varieties of disease-carrying sharpshooters, the glassy-winged sharpshooter is of particular concern due to its aggressive nature and ability to spread more quickly. In most cases, the glassy-winged sharpshooter feeds on the stems rather than the leaves. When feeding, the insect excretes copious amounts of watery excrement carrying the bacterium Xylella fastidiosa. Pierce' disease is the most prominent disease caused by the bacterium Xylella fastidiosa, which attacks the plants xylem, or water-conducting tissues and eventually chokes off the flow of water and nutrients within the plant. The disease will eventually kill or render grapevines or other plants unproductive within two to three years. Without an effective treatment, scientists fear the glassy-winged sharpshooter will spread throughout the San Joaquin Valley, threatening nearly 800,000 acres of wine, table, and raisin grapes. This amounts to more than 70% of California's grape crop. At this time, there are no effective treatments to stop the glassy-winged sharpshooter or the spread of Pierce's disease.

### SUMMARY OF THE INVENTION

The present invention relates to an antiviral, antibacterial, and antifungal composition and method for coating fruit producing, vegetable producing and ornamental trees and plants in order to protect against harmful and destructive organisms. The composition comprises: one or more quaternary ammonium compounds; a surfactant; 1-3, butylene glycol; a drying agent; a hydrophilic film forming agent; a hydrophobic water proofing agent; and water. In a preferred embodiment, the quaternary ammonium compounds are selected from the group consisting of: Benzalkonium Chloride; Myristalkonium chloride and Quaternium 14 (BTC 2125M); a mixture of N, N-Didecyl-N, N-dimethylammonium chloride and N-Alkyl-N, N-dimethyl-N-benzylammonium chloride (FMB 1210-8 Quat, manufactured by Lonza Inc.); Diisobutylphenoxyethoxyethyldimethylbenzylammonium chloride monohydrate (HYAMINE 1622-50%, manufactured by Lonza Inc.); or any quaternary ammonium compound having a chemical structure that includes four carbon groups attached to a nitrogen atom that is contemplated under the doctrine of equivalents. The surfactant is selected from the group consisting of: NP 9; Triton X-100; and Makon or any equivalent surfactant under the doctrine of equivalents. The drying agent is aluminum sulfate or any equivalent drying agent under the doctrine of equivalents. In a preferred embodiment, the hydrophilic film forming agent is Gantrez ES 225 or any equivalent hydrophilic film forming agent under the doctrine of equivalents. The hydrophobic water proofing agent is selected from the group consisting of: Copolymers 934, 940, or 734; and Ganax V220 or any equivalent hydrophobic water proofing agent under the doctrine of equivalents.

The composition and method of application provides a barrier of protection against parasites, fungi and other destructive organisms which attack the roots, stems, leaves and/or fruit or vegetables of plants and trees. Moreover, the composition provides a broad spectrum kill against these pathogens. Most significantly, the composition is useful for application to large areas of agriculture which come under attack from various contagious pathogens.

The composition can be applied to the exterior of plants and trees to form a protective coating for an instant kill of the contagious pathogens which come into contact with the protected plants. Additionally, the composition can be administered in a slow, therapeutic manner to kill the pathogens systemically, depending upon the strength of the affected tree or plant. More specifically, the composition can be administered through the root system of the tree or plant, in addition to or as an alternative to an exterior coating, thereby enabling treatment against organisms that are destructive to the cellular make up of a tree or plant. Systemic delivery of the composition is also useful to treat plants and trees which are infected with a pathogen, providing a therapeutic treatment which kills pathogens that have begun to attack the cellular structure of the infected plant.

The composition of the present invention is further useful as a pesticide to kill insects. In particular, the composition is effective in killing bacteria excreting insects such as the glassy-winged sharpshooter. The composition further kills the bacteria excreted by such insects. Specifically, the composition of the present invention is useful to kill the bacterium Xylella fastidiosa, as well as many other bacteria, viruses, fungi and other destructive microorganisms which attack agricultural crops and ornamental plants.

It is contemplated that the composition, when applied in accordance with the various methods thereof, will provide a means to combat many different organisms that attack trees and plants. Further, the ingredients in the composition are used in amounts that will not disturb the environment or threaten the health of farmers, field workers and consumers who handle and eat fruit which has been coated with the composition.

For external application to coat plants and trees, the composition can be sprayed using conventional irrigation equipment and other equipment which is presently used to spray a variety of trees and plants with pesticides. For systemic delivery, the composition is applied to the soil surrounding the base of the tree or plant, to enable the composition to be systemically absorbed through the root system. For treatment of certain plants infected with particularly contagious pathogens, isolated treatment may be necessary. In particular, application by brush, to apply the composition to the leaves, stems and/or trunk of an infected plant or tree, is one method of isolated treatment. Another isolated treatment method which can be effective to treat certain strains of contagious pathogens is injection treatment. This is accomplished with the use of a hypodermic needle and syringe to inject the composition into the infected site(s) on the plant leaves, stems and/or trunk.

### OBJECTS AND ADVANTAGES OF THE INVENTION

It is a primary object of the present invention to provide a composition and method of application of a composition for providing a barrier of protection against parasites, fungi, and other destructive organisms which attack the roots, stems, leaves, flowers and/or fruit or vegetables of plants and trees.

It is still a further object of the present invention to provide an antimicrobial composition and method of application of same to plants and trees to provide a broad scale kill of harmful organisms which attack plants and trees.

It is still a further object of the present invention to provide an antimicrobial composition, having antiviral, antibacterial, and antifungal properties, which can be applied to plants and trees by spray coating, brush coating, systemic delivery or injection in order to protect plants and trees from harmful and destructive organisms.

It is yet a further object of the present invention to provide an antimicrobial composition which is useful for application to large areas of agriculture which are threatened by attack of harmful and contagious pathogens.

It is yet a further object of the present invention to provide an antimicrobial composition which is highly effective in killing and stopping the spread of destructive organisms which attack the roots, stems, leaves, flowers, and/or fruits or vegetables of plants and trees including, but not limited to, citrus canker.

It is still a further object of the present invention to provide an antimicrobial composition, as set forth herein, which is adapted for systemic delivery to plants and trees which become infected with a harmful pathogen to provide a therapeutic treatment against such pathogens which attack the cellular structure of the infected plant.

It is still a further object of the present invention to provide an antimicrobial composition, as set forth herein, which comprises ingredients used in amounts which will not disturb the environment or threaten the health of farmers, field workers, and consumers who handle and consume fruit and vegetables which have been coated with the composition.

It is yet a further object of the present invention to provide a composition which is useful as a pesticide to kill a wide variety of insects including, but not limited to, the glassy-winged sharpshooter and other bacteria excreting insects.

It is still a further object of the present invention to provide a composition which is effective to kill a wide variety of bacteria including, but not limited to, the Xylella fastidiosa bacterium.

These and other objects and advantages of the invention are more readily apparent with reference to the foregoing summary and the detailed description which follows.

### DETAILED DESCRIPTION OF THE PREFERRED EMBODIMENTS

The present invention is directed to an antimicrobial composition for application to trees and plants in order to provide protection against harmful and contagious pathogens. More particularly, the composition of the present invention is useful to kill pathogens which have begun to attack the cellular structure of the leaves, stems, trunk and roots of a tree or plant. Moreover, the composition is useful to provide healthy trees and plants with a barrier of protection against parasites, fungi and other destructive organisms prior to infection. Still further, the composition of the present invention is useful as a pesticide to kill a wide variety of insects which attack plants, including bacteria excreting insects such as the glassy-winged sharpshooter. Additionally, the composition is useful to kill a wide variety of bacteria, including the bacteria excreted by insects, such as the bacterium Xylella fastidiosa which causes Pierce's disease. In accordance with the present invention, the composition can be manufactured to specified viscosities and other consistencies which are particular to a plant species and/or specific pathogen. Moreover, various formulas are contemplated within the scope of the invention. For instance, the formula may vary depending upon the desired method of application to treat a particular organism which has infected or threatens to infect a particular plant species. It is contemplated that the composition will be applied by various means including, but not limited to, aerial spraying, ground spraying, handheld spray application, brush application, direct injection to infected sites and systemic delivery through the root system of plants and trees.

In each of the examples of the composition, as set forth below, one or more functional compounds are used. Each functional compound is biologically active against a broad spectrum of viruses, bacteria, fungi, and other pathogenic species. In a preferred embodiment, the biologically active compound(s) includes one or more quaternary ammonium compounds. In the several examples which follow, the quaternary ammonium compound known by the trade name BTC 2125M, manufactured by Stepan, is used alone or in combination with other quaternary ammonium compounds. The one or more quaternary ammonium compounds are preferably present in the composition in an amount of between 10 ppm (0.001%) to 5,000 ppm (0.5%) by weight of the composition. BTC 2125M is a blend of Myristalkonium chloride and quaternium 14 and is shown by the general formula:

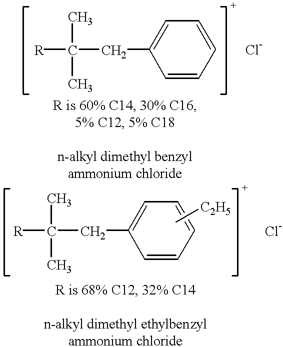

R is 60% C14, 30% C16, 5% C12, 5% C18

n-aklkyl dimethyl benzyl ammonium chloride

R is 68% C12, 32% C14

n-alkyl dimethyl ethylbenzyl ammonium chloride

Other examples of quaternary ammonium compounds which are contemplated within the scope of the invention, for use independently or in combination with BTC 2125M, include: BTC 50, manufactured by Stepan; FMB 1210-8 QUAT, manufactured by Lonza Inc.; HYAMINE 1622050%, manufactured by Lonza Inc.; or any compound having a chemical structure that includes four carbon groups attached to a nitrogen atom. BTC 50 is a mixture of alkylbenzyldimethylammonium chlorides, commonly known as benzalkonium chloride, of the general formula:

[C₆H₅CH₂N(CH₃)₂R] CL

wherein R is alkyl.

In some formulations of the composition, as set forth below, it is desirous to use a surfactant as a broad spreading agent. Various surfactants are well known to those skilled in the art and are contemplated within the spirit and scope of the invention. In particular, non-ionic surfactants known by the trade names Makon 10, Nonoxynol 9 and Triton X-100 are useful in several examples of the composition. Makon 10 is a non-ionic alkoxylate and is manufactured by Stepan Company. Makon 10 is known by the chemical description nonylphenol ethoxylate. Nonoxynol 9 is an ethoxylated nonylphenol containing nine moles of ethylene oxide and serves both as a non-ionic surfactant (spreading agent) and an antimicrobial agent. Triton X-100 is a polyoxyethylene ether, a non-ionic surfactant which also provides antimicrobial properties. In some instances, the combination of one or more quaternary ammonium compounds with a non-ionic surfactant produces a synergistic effect, producing substantially greater biocidal activity against certain pathogenic species. The surfactant, when used in the composition, is preferably present in the amount of between 0.5% to 15% by weight of the composition.

The composition further includes 1-3, butylene glycol as a stabilizer and wetting agent. When used in the composition, 1-3, butylene glycol is present in an amount of between 0.5% and 10% by weight of the composition.

Various embodiments of the composition of the present invention further include a hydrophobic water proofing compound. In particular, Ganax V-220, manufactured by Gaff Chemicals Corp., provides an ideal water proofing agent. Ganax V-220 is a polymer derived from vinylpyrrolidone and a long chain alpha olefin represented by the general formula:

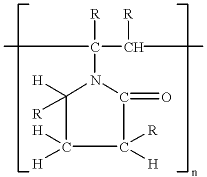

wherein R is alkyl or hydrogen.

In the preferred embodiment, the hydrophobic agent is a PVP/eicosene copolymer (polyvinlpyrrolidone and eicosene) and is present in the amount of between 0.1% and 10% by weight of the composition.

Several embodiments of the composition further include the use of a hydrophilic film forming compound. Various hydrophilic film forming agents are contemplated, including Gantrez ES 225, manufactured by ISP Technologies Inc. Gantrez ES 225 is known by the chemical name 2-butenedioic acid (2), monoethyl ester, polymer with methoxyethene.

The preferred species include alkyl monoesters of poly methyl vinyl ether/ maleic acid), represented by the following formula:

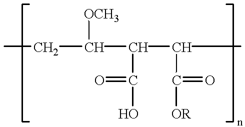

wherein R is ethyl, isopropyl or n-butyl.

When used, the hydrophilic film forming compound is present in an amount of between 0.25% and 15% by weight of the composition.

Aluminum sulfate is used as a drying agent and is present in the amount of between 0.5% and 15% by weight of the composition. Aluminum sulfate has also been found to exhibit fungicidal properties.

A resinous hydrophilic water swellable polymer may be used to provide thickening. While many resins are contemplated within the scope of the present invention, a cross-linked acrylic acid polymer, such as carbopol 940, manufactured by B. F. Goodrich, is selected. This acrylic acid polymer is in admixture with 3%-7% by weight of an inorganic silicate which is water insoluble. The inorganic silicate, such as Laponite XLG, distributed by Laparte, Inc., provides a support mechanism for the acrylic acid polymer. When used in the composition of the present invention, carbopol 940, or another resinous hydrophilic water swellable polymer is present in the amount of between 0.5% and 7% by weight of the composition.

The use of a catalyst may be necessary in some embodiments. The catalyst may be chosen from any of the known catalysts in the polymer industry, although in the present invention, Triethanolamine (TEA) is particularly suitable. Triethanolamine, used in a range of approximately 0.5% to 3.0% by weight, increases the hydration, swelling and thickening efficiency of the acrylic acid polymer.

Various formulas for use on specific plant species are set forth in the following examples:

### EXAMPLE 1

| Ingredient | Range (% by weight) |
|---|---|
| Benzalkonium Chloride | 0.001%-0.5% |
| Makon 10 | 0.5% to 15% |
| 1-3, Butylene Glycol | 0.5% to 10% |
| Aluminum Sulfate | 0.5% to 15% |
| Copolymer 940 or equivalent | 0.1% to 10% |
| Gantrez ES225 | 0.25% to 15% |
| Water | to 100% |

### EXAMPLE 2

| Ingredient | % by weight |
|---|---|
| Purified water | 83.77 |
| Benzalkonium chloride (BTC 50) | 1000 ppm |
| BTC 2125M | 0.08 |
| Makon 10 | 5.00 |
| 1-3, Butylene Glycol | 2.00 |
| Gantrez ES 225 | 1.00 |
| Aluminum sulfate | 8.00 |

The above formula is particularly useful for treatment of citrus canker which attacks the leaves, stems, and fruit of citrus trees, including but not limited to, orange trees, grapefruit trees, lemon trees, lime trees, key lime trees, and tangerine trees. In the above example, Benzalkonium chloride (BTC 50) is the active ingredient.

The composition is manufactured in accordance with the following procedure. First, in a high speed mixer, aluminum sulfate is added with water and mixed together at a high mixing speed to produce a first mixture. Next, Gantrez ES 225 is added to the first mixture and mixed at a high speed, blending until there are no lumps remaining. Blending is continued at a slow speed until the combined aluminum sulfate, water and Gantrez ES 225 are completely blended in a homogenous mixture, thereby defining a second mixture. In a separate mixer, 1-3, butylene glycol, BTC 50 and BTC 2125M are blended together at slow speed, until completely blended to produce a third mixture. The second mixture is then added to the third mixture at a slow speed and mixing is continued until the two mixtures are completely blended together, producing a fourth mixture. Then, Makon 10 is added to the fourth mixture and blended at a slow speed mix until a final homogenous mixture is achieved.

The above formula is applied to citrus trees by aerial spraying, truck spraying, irrigation spraying, or other means of spray application to coat the leaves, fruit, stems, trunk and other exterior surfaces of the tree and fruit. The composition may also be sprayed at the base of citrus trees for systemic absorption through the roots of the tree. Systemic delivery may be used in conjunction with, or as an alternative to, external spray application.

### EXAMPLE 3

| Ingredient | % by weight |
|---|---|
| Purified water | 83.92 |
| BTC 2125M | 200 ppm |
| Makon 10 | 5.00 |
| 1-3, Butylene Glycol | 2.00 |
| Gantrez ES 225 | 1.00 |
| Aluminum sulfate | 8.00 |

The above formula is also useful for treatment of citrus canker. The composition is prepared in accordance with the same general mixing procedure as described in connection with Example 2, with the exception that BTC 50 is removed from the formula. In this particular example, BTC 2125M is the active ingredient.

### EXAMPLE 4

| Ingredient | % by weight |
|---|---|
| BTC 50 | 4500 ppm |
| BTC 2125M | 500 ppm |
| NP 9 | 8% |
| 1-3, Butylene Glycol | 6% |
| Aluminum sulfate | 9% |
| Gantrez ES 225 | 3% |
| Copolymer 940 | 2% |
| Ganax V220 | 2% |
| Water | 100% of formula |

Problem: Mites and other insect infestation

Manner of application: Topical spray application to fruit, leaves, stem and trunk EXAMPLE 5

| Ingredient | % by weight |
|---|---|
| BTC 50 | 1000 ppm |
| BTC 2125M | 200 ppm |
| NP 9 | 5% |
| Gantrez ES 225 | 5% |
| 1-3, Butylene Glycol | 4% |
| Water | to 100% of formula |

Problem: Venticillium wilt

Manner of application: Systemic delivery

### EXAMPLE 6

| Ingredient | % by weight |
|---|---|
| BTC 50 | 2000 ppm |
| BTC 2125M | 150 ppm |
| Aluminum sulfate | 10% |
| 1-3, Butylene Glycol | 5% |
| Water | to 100% of formula |

Problem: Bacterial canker

Manner of application: Injection treatment using hypodermic needle and syringe to infected site

### EXAMPLE 7

| Ingredient | % by weight |
|---|---|
| BTC 50 | 1000 ppm |
| BTC 2125M | 300 ppm |
| Aluminum sulfate | 8% |
| Gantrez ES 225 | 6% |
| Triton X-100 or NP9 | 6% |
| Water | to 100% of formula |

Problem: Bacterial leaf spots

Manner of application: Topical spray application to leaves

### EXAMPLE 8

| Ingredient | % by weight |
|---|---|
| BTC 50 | 500 ppm |
| BTC 2125M | 800 ppm |
| Triton X-100 | 5% |
| Aluminum sulfate | 3% |
| 1-3 Butylene Glycol | 4% |
| Gantrez ES 225 | 2% |
| Water | to 100% of formula |

Problem: Panicum mosaic plant virus

Manner of application: Topical spraying and systemic delivery

### EXAMPLE 9

| Ingredient | % by weight |
|---|---|
| BTC 50 | 1000 ppm |
| BTC 2125M | 250 ppm |
| 1-3, Butylene Glycol | 1% |
| Gantrez ES 225 | 1.5% |
| Water | to 100% of formula |

Problem: Fusarium

Manner of application: Topical spraying and systemic delivery

### EXAMPLE 10

| Ingredient | % by weight |
|---|---|
| BTC 50 | 800 ppm |
| BTC 2125M | 500 ppm |
| Triton X-100 | 3% |
| Ganax V220 | 2% |
| Gantrez ES 225 | 2% |
| 1-3, Butylene Glycol | 1.5% |
| Water | to 100% of formula |

Problem: Leaf miners
Manner of application: Topical spraying

### EXAMPLE 11

| Ingredient | % by weight |
|---|---|
| BTC 50 | 1000 ppm |
| BTC 2125M | 300 ppm |
| Aluminum sulfate | 5% |
| Ganax V220 | .5% |
| Carbopol 940 | 2% |
| 1-3, Butylene Glycol | 5% |
| Gantrez ES 225 | 3% |
| Triton X-100 or NP 9 | 6% |
| Triethanolamine (Catalyst) | 1% |
| Water | to 100% of formula |

Problem: Red Bud Canker

Manner of application: Paint on to leaves, stems and bark, at infected areas using a brush. This formula is particularly thick and water proof to provide a long lasting contact kill and barrier of protection.

The above composition is prepared in accordance with the following procedure. First, in a stainless steel mixing tank, one-half of the amount of water is heated to 70° Celsius while sifting in the carbopol 940 at a high sheer mix speed to produce a first mixture. When the temperature of the first mixture reaches 70° Celsius, Ganax V220 is added at high speed mix until completely blended to produce a second mixture. The second mixture is held at a temperature of 70° Celsius for 15 minutes. In a separate stainless steel mixing tank, one quarter of the amount of water and aluminum sulfate are mixed until in solution, thereby defining a third mixture. The third mixture is combined with the second mixture and mixed at high speed mix to produce a fourth mixture. Next, Gantrez ES 225 is added to the fourth mixture at high speed mix, while cooling, to produce a fifth mixture. In a third stainless steel mixing tank, 1-3, butylene glycol, BTC 50, and BTC 2125M are combined and mixed by stirring to produce a sixth mixture. Then, the mix speed of the fifth mixture is slowed down to a slow stir speed, while adding the sixth mixture, continuing to stir at a slow speed. Next, while continuing to stir at a very slow stir mix speed, the remaining water and Triton X or NP 9 are added. Finally, Triethanolamine is added while slow stirring until all of the ingredients are completely blended in a homogenous thick gel solution to produce the final mixture.

### EXAMPLE 12

| Ingredient | % by weight |
|---|---|
| BTC 50 | 600 ppm |
| BTC 2125M | 250 ppm |
| Gantrez ES 225 | 1% |
| Ganax | .25% |
| NP 9 | 2% |
| 1-3, Butylene Glycol | 1.5% |
| Water | to 100% of formula |

Problem: Nemadoles

Manner of application: Systemic delivery

The above composition is prepared in accordance with the following procedure. First, in a stainless steel mixing tank, one-half of the amount of water is heated to 70° Celsius. Next, Ganax V220 is added and mixed at high speed for 15 minutes, until all of the Ganax V220 is in solution to produce a first mixture. The first mixture is allowed to cool and, next, Gantrez ES 225 is added to the first mixture while continuing to mix at high speed to produce a second mixture. In a separate stainless steel mixing tank, 1-3 butylene glycol, BTC 50, and BTC 2125M are combined and blended by slow stirring until the three ingredients are completely blended, producing a third mixture. Next, the second mixture and third mixture are combined and blended at a slow stir speed. Finally, the remaining water and NP 9 are added and mixed using a very slow stir speed until all of the ingredients are blended to a homogenous mixture.

### EXAMPLE 13

| Ingredient | % by weight |
|---|---|
| BTC 50 | 25 ppm |
| BTC 2125M | 25 ppm |
| 1-3, Butylene Glycol | .5% |
| Gantrez ES 225 | .5% |
| NP 9 | 1% |
| Water | to 100% |

Problem: Preventative formula

Manner of application: Spray application and/or systemic delivery

While the instant invention has been shown and described in accordance with various preferred and practical embodiments thereof, it is recognized that the invention is not limited to the above examples and departures from the instant disclosure may be made within the spirit and scope of the invention as interpreted under the U.S. patent law.

What is claimed is:

1. A composition for protecting trees and plants from harmful and destructive organisms, said composition comprising:
at least one quaternary ammonium compound;
a stabilizer;
a drying agent; and
water.

2. The composition as recited in claim 1 further comprising:
a hydrophobic water proofing compound.

3. The composition as recited in claim 1 further comprising:
a hydrophilic film forming compound.

4. The composition as recited in claim 1 further comprising:
a hydrophobic water proofing compound; and
a hydrophilic film forming compound.

5. The composition as recited in claim 4 further comprising:
a surfactant.

6. The composition as recited in claim 1 wherein said at least one quaternary ammonium compound is Benzalkonium chloride.

7. The composition as recited in claim 1 wherein said at least one quaternary ammonium compound is Myristalkonium chloride and Quaternium 14.

8. The composition as recited in claim 1 wherein said at least one quaternary ammonium compound is a mixture of N, N-Didecyl-N, N-dimethylammonium chloride and N-Alkyl-N, N-dimethyl-N-benzylammonium chloride.

9. The composition as recited in claim 1 wherein said at least one quaternary ammonium compound is Diisobutylphenoxyethoxyethyldimethylbenzylammonium chloride.

10. The composition as recited in claim 2 wherein said hydrophobic water proofing compound comprises polyvinlpyrrolidone and Eicosene.

11. The composition as recited in claim 3 wherein said hydrophilic film forming compound is a copolymer of monoethyl ester of poly (methyl vinyl ether) and maleic acid.

12. The composition as recited in claim 5 wherein said surfactant comprises a polyoxyethylene ether.

13. The composition as recited in claim 5 wherein said surfactant comprises a nonylphenol ethoxylate.

14. The composition as recited in claim 5 wherein said surfactant comprises an ethoxylated nonylphenol containing nine moles of ethylene oxide.

15. The composition as recited in claim 1 wherein said stabilizer comprises 1-3, butylene glycol.

16. The composition as recited in claim 1 wherein said drying agent comprises aluminum sulfate.

17. A composition for protecting trees and plants from harmful and destructive organisms, said composition comprising:
at least one quaternary ammonium compound in an amount between 0.00005% -0.00005% by weight of said composition;
a stabilizer in an amount of between 0.5% and 10.0% by weight of said composition;
a hydrophilic film forming compound in an amount of between 0.25% -15.0% by weight of said composition;
a drying agent in an amount of between 0.5% -15.0% by weight of said composition; and
water.

18. The composition as recited in claim 17 further comprising:
a hydrophobic agent in an amount of between 0.1% -10.0% by weight of said composition.

19. A composition for protecting trees and plants from harmful and destructive organisms, said composition comprising:
one or more quaternary ammonium compounds selected from the group consisting of:
Benzalkonium chloride; Myristalkonium chloride and Quaternium 14; a mixture of N, N-Didecyl-N, N-dimethylammonium chloride and N-Alkyl-N, N-dimethyl-N-benzylammonium chloride; and
Diisobutylphenoxyethoxyethyldimethylbenzylammonium chloride mono hydrate; said one or more quaternary ammonium compounds being present in an amount of between 0.00005% - 0.5% by weight of said composition;
a stabilizer in an amount of between 0.5% -10.0% by weight of said composition;
a drying agent in an amount of between 0.5% -15% by weight of said composition;
a hydrophilic film forming compound in an amount of between 0.25% -15.0% by weight of said composition;
a hydrophobic water proofing compound in an amount of between 0.1% -10.0% by weight of said composition; and
water.
